(19) United States
(12) Patent Application Publication
(10) Pub. No.: US 2006/0089435 A1
(43) Pub. Date: Apr. 27, 2006

(54) Flameproof agent-stabiliser-combination for thermoplastic polymers

(75) Inventors: Sebastian Hoerold, Diedorf (DE); Wolfgang Wanzke, Augsburg (DE); Ottmar Schacker, Gersthofen (DE); Bernd Nass, Augsburg (DE); Martin Sicken, Koeln (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH, Frankfurt Am Main (DE)

(21) Appl. No.: 10/526,691

(22) PCT Filed: Aug. 26, 2003
(86) PCT No.: PCT/EP03/09434

§ 371 Date: Sep. 26, 2005

(30) Foreign Application Priority Data
Sep. 3, 2002 (DE) 102 41 126.3

(51) Int. Cl. C08K 5/49

(52) U.S. Cl. 524/115

(57) ABSTRACT

A flame retardant-stabilizer combination for thermoplastic polymers, comprising, as component A, from 25 to 99.9% by weight of a phosphinic acid salt of the formula (I) and/or of a diphosphinic acid salt of the formula (II) and/or polymers thereof, as component B, from 0 to 75% by weight of a nitrogen-containing synergist or of a phosphorus/nitrogen flame retardant and, as component C, from 0.1 to 50% by weight of magnesium oxide, zinc oxide, manganese oxide, tin oxide, dihydrotalcite, hydrocalumite, magnesium hydroxide, calcium hydroxide, zinc hydroxide, tin oxide hydrate, manganese hydroxide, zinc borate, basic zinc silicate, zinc stannate or mixtures of these substances, the sum of the components always being 100% by weight.

The invention relates to a flame retardant-stabilizer combination for thermoplastic polymers, and also to polymeric molding compositions which comprise such flame retardant-stabilizer combinations.

With few exceptions, thermoplastics are processed in the melt. Hardly any plastic can withstand the associated changes in structure and state without changing in its chemical structure. Crosslinking, oxidation, molecular weight changes and therefore also changes in the physical and technical properties may be the consequence. In order to reduce the thermal stress on the polymers during processing, various additives are added depending on the plastic. In general, stabilizers are added which stop or at least slow the change processes such as crosslinking or decomposition reactions. In addition, lubricants which are added to most plastics primarily have the task of improving the flow behavior of the melt.

In general, a multitude of different additives is used at the same time, each of which alone assume one task. For instance, antioxidants and stabilizers are used so that the plastic survives the processing without chemical change and is subsequently stable for a long time against external influences such as heat, UV light, weathering and oxygen (air). In addition to the improvement in the flow behavior, lubricants prevent excessively strong sticking of the plastics melt to hot machine parts and function as a dispersant for pigments, fillers and reinforcers.

The use of flame retardants can influence the stability of the plastic in the course of processing in the melt. Flame retardants frequently have to be used in high dosages, in order to ensure adequate flame resistance of the plastic by international standards. As a consequence of their chemical reactivity which is required for flame retardancy at high temperatures, flame retardants can impair the processing stability of plastics. For example, increased polymer degradation, crosslinking reactions, emissions of gas or discolorations may occur. These are effects which occur to a lesser extent, or possibly not at all, in the course of plastics processing without flame retardants.

Without the addition of flame retardants, polyamides are generally stabilized by small amounts of copper halides and also aromatic amines and sterically hindered phenols, the achievement of long-term stability at high long-term use temperatures coming to the fore (H. Zweifel (Ed.): “Plastics Additives Handbook”, 5th Edition, Carl Hanser Verlag, Munich, 2000, pages 80 to 84). Polyesters too require antioxidative stabilization mainly for long-term use, but not for the processing operation.

For thermoplastic polymers in particular, salts of phosphinic acids (phosphinates) have been found to be effective flame-retardant additives (DE-A-2 252 258 and DE-A-2 447 727). It has been stated that calcium and aluminum phosphinates are particularly effective in polyesters and impair the material properties of the polymer molding compositions less than, for example, the alkali metal salts (EP-A-0 699 708).

Moreover, synergistic combinations have been found of phosphinates with certain nitrogen compounds and are more effective as flame retardants in a whole series of polymers than the phosphinates alone (PCT/EP97/01664 and also DE-A-197 34 437 and DE-A-197 37 727).

For stabilization of polymer molding compositions with phosphorus flame retardants, carbodiimides, isocyanates and isocyanurates have been found to be effective (DE-A-199 20 276).

Especially in the case of the use of phosphorus flame retardants in polyamides and polyesters, the effectiveness of the stabilizers as described hitherto has been found to be insufficient, especially in order to suppress the effects occurring in the course of processing such as discoloration and molecular weight reduction.

DE-A-196 14 424 describes phosphinates in combination with nitrogen-containing synergists in polyesters and polyamides. DE-A-199 33 901 describes phosphinates in combination with melamine polyphosphate as a flame retardant for polyesters and polyamides. However, the use of these newly developed, very effective flame retardants can lead to partial polymer degradation and also to discoloration of the polymer, especially at processing temperatures above 300° C. In the course of extrusion and injection molding, troublesome smoke evolution is sometimes observed.

It is therefore an object of the present invention to provide flame retardant combinations for thermoplastics, said flame retardant combinations, in addition to flame retardancy, exerting a stabilizing action on the plastic. This object is achieved by the addition of basic or amphoteric oxides, hydroxides, carbonates, silicates, borates, stannates, mixed oxide hydroxides, oxide hydroxide carbonates, hydroxide silicates or hydroxide borates or mixtures of these substances, coupled with the use of phosphinates or their mixtures with nitrogen-containing synergists as flame retardants.

The invention therefore provides a flame retardant-stabilizer combination for thermoplastic polymers, comprising, as component A, from 25 to 99.9% by weight of a phosphinic acid salt of the formula (I) and/or of a diphosphinic acid salt of the formula (II) and/or polymers thereof 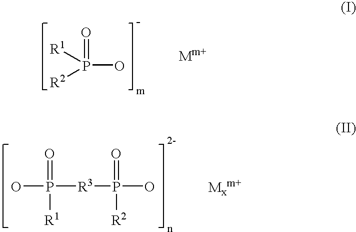
where
R¹, R² are the same or different and are each C₁-C₆-alkyl, linear or branched, and/or aryl;
R³ is C₁-C₁₀-alkylene, linear or branched, C₆-C₁₀-arylene, -alkylarylene or -arylalkylene;
M is Mg, Ca, Al, Sb, Sn, Ge, Ti, Zn, Fe, Zr, Ce, Bi, Sr, Mn, Li, Na, K and/or a protonated nitrogen base;
m is from 1 to 4;
n is from 1 to 4;
x is from 1 to 4,
   as component B, from 0 to 75% by weight of a nitrogen-containing synergist or of a phosphorus/nitrogen flame retardant and,
   as component C, from 0.1 to 50% by weight of magnesium oxide, zinc oxide, manganese oxide, tin oxide, dihydrotalcite, hydrocalumite, magnesium hydroxide, calcium hydroxide, zinc hydroxide, tin oxide hydrate, manganese hydroxide, zinc borate, basic zinc silicate, zinc stannate or mixtures of these substances, the sum of the components always being 100% by weight.

It has been found that, surprisingly, inventive combinations of phosphinates and optionally nitrogen-containing synergists, for example melamine polyphosphate, have distinctly improved stability in the course of incorporation into polymers when certain oxides, hydroxides, carbonates, silicates, borates, stannates, mixed oxide hydroxides, oxide hydroxide carbonates, hydroxide silicates or hydroxide borates or mixtures of these substances are added. For example, magnesium oxide, calcium oxide, aluminum oxide, zinc oxide, manganese oxide, tin oxide, aluminum hydroxide, boehmite, dihydrotalcite, hydrocalumite, magnesium hydroxide, calcium hydroxide, zinc hydroxide, tin oxide hydrate, manganese hydroxide, zinc borate, basic zinc silicate or zinc stannate can be used.

The inventive combinations reduce the discoloration of the plastics in the course of processing in the melt and suppress the decomposition of the plastics to give units of low molecular weight. At the same time, the flame resistance is retained to the full.

It has also been found that, surprisingly, the inventive additives completely eliminate smoke evolution in the course of extrusion and injection molding.

M is preferably calcium, aluminum or zinc.

The protonated nitrogen bases are preferably the protonated bases of ammonia, melamine, triethanolamine, in particular NH₄⁺.

R¹, R² are the same or different and are preferably each C₁-C₆-alkyl, linear or branched, and/or phenyl.

R¹, R² are the same or different and are more preferably each methyl, ethyl, n-propyl, isopropyl, n-butyl, tert-butyl, n-pentyl and/or phenyl.

R³ is preferably methylene, ethylene, n-propylene, isopropylene, n-butylene, tert-butylene, n-pentylene, n-octylene or n-dodecylene.

R³ is preferably also phenylene or naphthylene.

Suitable phosphinates are described in PCT/WO97/39053, which is fully incorporated herein by way of reference.

Particularly preferred phosphinates are aluminum, calcium and zinc phosphinates.

Also in accordance with the invention are synergistic combinations of the phosphinates specified with nitrogen compounds, said synergistic combinations being more effective as flame retardants in a whole series of polymers than the phosphinates alone (DE-A-196 14 424, DE-A-197 34 437 and DE-A-197 37 727). The flame retardancy of the phosphinates can be improved by combination with further flame retardants, preferably nitrogen synergists or phosphor/nitrogen flame retardants.

The nitrogen synergists are preferably those of the formulae (III) to (VIII) or mixtures thereof 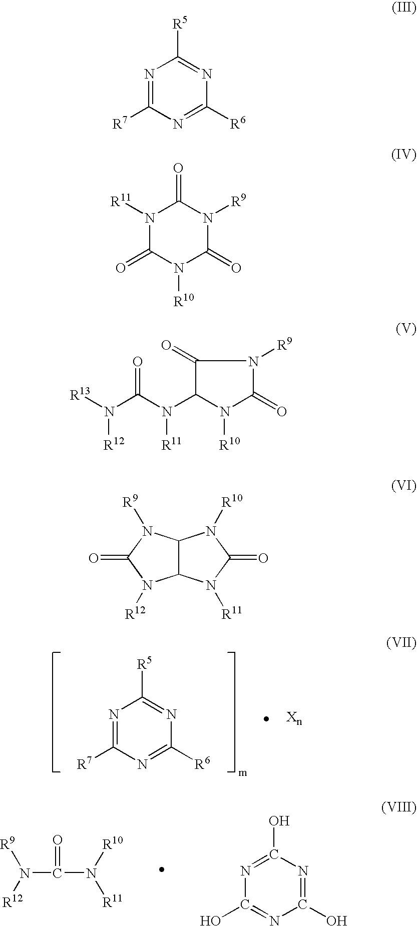
where
R⁵to R⁷ are each hydrogen, C₁-C₈-alkyl, C₅-C₁₆-cycloalkyl or -alkylcycloalkyl, possibly substituted by a hydroxyl or a C₁-C₄-hydroxyalkyl function, C₂-C₈-alkenyl, C₁-C₈-alkoxy, -acyl, -acyloxy, C₆-C₁₂-aryl or -arylalkyl, —OR⁸ and —N(R⁸)R⁹, N-alicyclic or N-aromatic,
R⁸ is hydrogen, C₁-C₈-alkyl, C₅-C₁₆-cycloalkyl or -alkylcycloalkyl, possibly substituted by a hydroxyl or a C₁-C₄-hydroxyalkyl function, C₂-C₈-alkenyl, C₁-C₈-alkoxy, -acyl, -acyloxy or C₆-C₁₂-aryl or -arylalkyl,
R⁹ to R¹³ are each the same groups as R⁸ and also —O—R⁸,
m and n are each independently of 1, 2, 3 or 4,
X is acids which can form adducts with triazine compounds (III);
   or oligomeric esters of tris(hydroxyethyl) isocyanurate with aromatic polycarboxylic acids.

The nitrogen synergists are preferably benzoguanamine, tris(hydroxyethyl) isocyanurate, allantoin, glycoluril, melamine, melamine cyanurate, dicyandiamide, guanidine, carbodiimides, zinc borate

The nitrogen synergists are preferably condensation products of melamine. Condensation products of melamine are, for example, melem, melam or melon, or highly condensed compounds of this type, and also mixtures thereof, and can be prepared, for example, by a process as described in WO-A-96/16948.

The phosphorus/nitrogen flame retardants are preferably reaction products of melamine with phosphoric acids or condensed phosphoric acids, or reaction products of condensation products of melamine with phosphoric acid or condensed phosphoric acids, or else mixtures of the products specified.

In this context, the reaction products with phosphoric acid or condensed phosphoric acids are compounds which result from reaction of melamine or the condensed melamine compounds, such as melam, melem or melon, etc., with phosphoric acid. Examples thereof are dimelamine phosphate, dimelamine pyrophosphate, melamine phosphate, melamine pyrophosphate, melamine polyphosphate, melam polyphosphate, melon polyphosphate and melem polyphosphate, and mixed polysalts, as described, for example, in WO 98/39306.

The phosphorus/nitrogen flame retardant is more preferably melamine polyphosphate.

The phosphorus/nitrogen flame retardants are preferably nitrogen-containing phosphates of the formulae (NH₄)_{y} H_{3-y} PO₄ or (NH₄ PO₃)_{z}, where y is from 1 to 3 and z is from 1 to 10 000.

The phosphorus/nitrogen flame retardants are preferably ammonium hydrogenphosphate, ammonium dihydrogenphosphate or ammonium polyphosphate.

The metal oxides are preferably magnesium oxide, zinc oxide, manganese oxide and/or tin oxide.

The hydroxides are preferably magnesium hydroxide, hydrotalcite, hydrocalumite, calcium hydroxide, zinc hydroxide, tin oxide hydrate and/or manganese hydroxide.

Component C is preferably zinc borate, basic zinc silicate or zinc stannate.

Component C is more preferably magnesium hydroxide, zinc oxide, dihydrotalcite or boehmite.

The ratios of components A, B and C in flame retardant-stabilizer combination depends substantially on the intended field of application and may vary within wide limits. Depending on the field of application, the flame retardant-stabilizer combinations comprise from 25 to 99.9% by weight of component A, from 0 to 75% by weight of component B and from 0.1 to 50% by weight of component C.

A flame retardant-stabilizer combination preferably comprises from 50 to 90% by weight of component A, from 0 to 50% by weight of component B and from 1 to 20% by weight of component C.

A flame retardant-stabilizer combination more preferably comprises from 50 to 80% by weight of component A, from 20 to 50% by weight of component B and from 2 to 20% by weight of component C.

In a particular embodiment, the flame retardant combination contains out 60 to 98% by weight of component A and 2 to 40% by weight of component C.

The flame retardant-stabilizer combination according to the invention may also comprise carbodiimides.

The invention also relates to a flame-retardant plastics molding composition comprising the flame retardant-stabilizer combination according to the invention.

The plastics are preferably thermoplastic polymers of the type high-impact polystyrene, polyphenylene ether, polyamides, polyesters, polycarbonates and blends or polymer blends of the type ABS (acrylonitrile-butadiene-styrene) or PC/ABS (polycarbonate/acrylonitrile-butadiene-styrene) or PPE/HIPS (polyphenylene ether/HI polystyrene) plastics.

The plastics are more preferably polyamides, polyesters and PPE/HIPS blends. Preference is given to using the flame retardant-stabilizer combination in the plastics molding composition in a total amount of from 2 to 50% by weight, based on the plastics molding composition.

Particular preference is given to using a flame retardant-stabilizer combination in the plastics molding composition in a total amount of from 10 to 30% by weight, based on the plastics molding composition.

Finally, the invention also relates to polymer shaped bodies, films, threads and fibers, each comprising a flame retardant-stabilizer combination according to the invention.

The polymer shaped bodies, films, threads and fibers are high-impact polystyrene, polyphenylene ethers, polyamides, polyesters, polycarbonates and blends or polymer blends of the type ABS (acrylonitrile-butadiene-styrene) or PC/ABS (polycarbonate/acrylonitrile-butadiene-styrene), polyamide, polyester and/or ABS.

The polymer shaped bodies, films, threads and fibers preferably each contain the flame retardant-stabilizer combination in a total amount of from 2 to 50% by weight, based on the polymer content.

The polymer shaped bodies, films, threads and fibers more preferably contain the flame retardant-stabilizer combination in a total amount of from 10 to 30% by weight, based on the polymer content.

In a particular embodiment, the polymer shaped bodies, films, threads and fibers contain from 2 to 30% by weight of the flame retardant-stabilizer combination, consisting of from 50 to 80% by weight of component A, from 20 to 50% by weight of component B and from 2 to 20% by weight of component C, based on the polymer content.

In a particular embodiment, the polymer shaped bodies, films, threads and fibers contain from 2 to 30% by weight of the flame retardant-stabilizer combination, consisting of from 60 to 98% by weight of component A and from 2 to 40% by weight of component C, based on the polymer content.

The aforementioned additives can be incorporated into the plastics in highly varying process steps. For instance, it is possible in the case of polyamides or polyesters to incorporate the additives into the polymer melt as early as the beginning, or at the end, of the polymerization/polycondensation or in a following compounding operation. In addition, there are processing operations in which the additives are not added until later. This is practiced in particular when pigment or additive masterbatches are used. There is also the possibility of drum application, especially of pulverulent additives, to the polymer granules which may possibly still be warm as a result of the drying operation.

The flame retardant-stabilizer combination is preferably present as granules, flakes, fine particles, powder and/or micronized material.

The flame retardant-stabilizer combination is preferably present as a physical mixture of the solids, as a melt mixture, as compacted material, as an extrudate or in the form of a masterbatch.

Preference is given to using the mixture in a molding composition of a polyamide or of a polyester. Suitable polyamides are described, for example, in DE-A-199 20 276.

The polyamides are preferably those of the amino acid type and/or of the diamine and dicarboxylic acid type.

The polyamides are preferably nylon-6 and/or nylon-66.

The polyamides are preferably unmodified, colored, filled, unfilled, reinforced, unreinforced, or else otherwise modified.

The polyesters are preferably polyethylene terephthalate or polybutylene phthalate.

The polyesters are preferably unmodified, colored, filled unfilled, reinforced, unreinforced or else otherwise modified.

Carbodiimides may additionally be present.

Optionally, further additives may be added to the polymers. Additives which may be added include waxes, light protectants, stabilizers, antioxidants, antistats or mixtures of such additives.

Stabilizers which may used with preference include phosphonites and phosphites or carbodiimides.

The aforementioned additives may also be added to the flame retardant-stabilizer combination.

### EXAMPLES

1. Components Used

Standard commercial polymers (granules):

| | |
|---|---|
| Nylon-6,6 (GFR PA 6,6): | ® Durethan AKV 30 (Bayer AG, D) |
| | contains 30% glass fibers. |
| Polybutylene terephthalate | ® Celanex 2300 GV1/30 (Ticona, D) |
| (GFR PBT): | contains 30% glass fibers. |

Flame retardant components (pulverulent):
Aluminum salts of diethylphosphinic acid, referred to hereinbelow as DEPAL.
Melapur 200 (melamine polyphosphate), referred to hereinbelow as MPP, from DSM Melapur, NL
Zinkoxyd aktiv, Bayer AG, D
Magnesium hydroxide: Magnifin H 10, Martinswerk, D
Boehmite, Nabaltec, D
Dihydrotalcite: DHT 4A, Kyowa Chemicals, Japan
   2. Production, Processing and Testing of Flame-Retardant Plastics Molding Compositions

The flame-retardant components were mixed with the polymer granules, lubricants and stabilizers in the ratio specified in the tables and incorporated in a Leistritz LSM 30/34 double-screw extruder at temperatures of from 260 to 310° C. (GFR PA-6,6) or from 240 to 280° C. (GFR PBT). The homogenized polymer strand was drawn off, cooled in a water bath and then granulated.

After sufficient drying, the molding compositions were processed to give test specimens on a Arburg 320 C Allrounder injection molding machine at temperatures of from 270 to 320° C. (GFR PA-6,6) or from 260 to 280° C. (GFR PBT) and, with the aid of the UL 94 test (Underwriter Laboratories), were tested for flame resistance and classified.

The flowability of the molding composition was determined by determining the melt volume index (MVR) at 275° C./2.16 kg. A sharp rise in the MVR value indicated polymer degradation.

The processing properties in polyester were assessed with reference to the specific viscosity (SV). After sufficient drying, the plastics molding composition granules were used to prepare a 1.0% solution in dichloroacetic acid and the SV value was determined. The higher the SV value is, the lower was the polymer degradation during the incorporation of the flame retardant.

Unless stated otherwise, all experiments of a particular series were carried out under identical conditions (temperature program, screw geometries, injection molding parameters, etc.) for the purpose of comparability.

Tables 1 and 3 show comparative examples in which a flame retardant combination based on the aluminum salt of diethylphosphinic acid (DEPAL) and the nitrogen-containing synergist melamine polyphosphate (MPP), and the metal oxide or hydroxide were used alone.

The results of the experiments in which the flame retardant composition according to the invention was used are listed in tables 2 and 4. All amounts are quoted as percentages by weight and are based on the plastics molding composition including the flame retardant combination additives.

It is evident from the examples that the additives according to the invention (mixture of the components phosphinate, nitrogen-containing synergist and oxide or hydroxide or mixed oxide hydroxide or oxide hydroxide carbonate) distinctly improve the processibility of the polymers without impairing the flame retardancy.

The incorporation of the flame retardant in PA-6,6 leads to polymer degradation, recognizable by high MVR values, and to gray-brown discoloration of the molding compositions (C2, C3, C4). The sole addition of oxide or hydroxide or mixed oxide hydroxide or oxide hydroxide carbonate does not result in any flame retardancy being achieved (C5, C6, C7, C8, C9).

Thus, when an inventive flame retardant-stabilizer combination of phosphinate, nitrogen-containing synergist and oxide or hydroxide or mixed oxide hydroxide or oxide hydroxide carbonate (E1, E2, E3, E4, E5, E6), a distinct stabilization of the flame-retardants polyamide melt and a distinct reduction in the discoloration of the test specimens can be detected.

The incorporation of the flame retardants into the polyester (PBT), both via DEPAL and via melamine polyphosphate, leads to polymer degradation, recognizable by reduction in the SV number and yellow discoloration. The combination if DEPAL and melamine polyphosphate leads to V-0 classification at 15% by weight flame retardants. Oxides or hydroxides or mixed oxide hydroxides or oxide hydroxide carbonates alone exhibit virtually no effectiveness as flame retardants (table 3).

In the flame-retardants polyester (PBT), the employment of the inventive combination of phosphinate, nitrogen-containing synergist and metal oxide or hydroxide leads to distinctly reduced polymer degradation, recognizable by high SV values, and a distinct reduction in discoloration being found (table 4).

Unless stated otherwise, the amounts quoted are always in percent by weight.

TABLE 1
Comparative examples (experimental series1): flame-retardant molding compositions
comprising the components as individual additives in glass fiber-reinforced PA-6,6.

| | DEPAL | MPP | | UL 94 class | MVR | |
|---|---|---|---|---|---|---|
| Comparison | [%] | [%] | Metal oxide | (0.8 mm) | [cm³/10′] | Color* |
| C1 | 0 | 0 | 0 | n.c.**⁾ | 19 | white |
| C2 | 10 | 5 | 0 | V-0 | 44 | gray-brown |
| C3 | 0 | 10 | 0 | n.c. | 55 | gray |
| C4 | 10 | 0 | 0 | V-2 | 20 | brown |
| C5 | 0 | 0 | 5% dihydrotalcite | n.c. | 21 | white |
| C6 | 0 | 0 | 5% boehmite | n.c. | 21 | white |
| C7 | 0 | 0 | 5% manganese oxide | n.c. | 21 | white |
| C8 | 0 | 0 | 5% zinc oxide | n.c. | 21 | white |
| C9 | 0 | 0 | 5% magnesium hydroxide | n.c. | 25 | white |

*of test specimen, melt temperature on injection molding: 300° C.
**⁾n.c. = not classifiable

TABLE 2
Inventive example: flame-retardant molding compositions comprising the combination
of DEPAL with nitrogen-containing synergist and metal oxide or hydroxide in glass
fiber-reinforced PA-6,6.

| | DEPAL | MPP | | UL 94 class | MVR | |
|---|---|---|---|---|---|---|
| Example | [%] | [%] | Metal oxide | (0.8 mm) | [cm³/10′] | Color* |
| E1 | 10 | 5 | 2% zinc oxide | V-0 | 19 | white |
| E2 | 10 | 5 | 5% magnesium hydroxide | V-0 | 17 | white |
| E3 | 10 | 5 | 2% magnesium hydroxide | V-0 | 21 | white |
| E4 | 10 | 5 | 2% boehmite | V-0 | 20 | white |
| E5 | 10 | 5 | 2% dihydrotalcite | V-0 | 21 | white |
| E6 | 10 | 5 | 2% manganese oxide | V-0 | 24 | white |

*of test specimen, melt temperature on injection molding: 300° C.

TABLE 3
Comparative examples: flame-retardant molding compositions comprising the
components as individual additives in glass fiber-reinforced PBT

| | DEPAL | | | UL 94 class | | |
|---|---|---|---|---|---|---|
| Comparison | [%] | MPP [%] | Metal oxide | (0.8 mm) | SV number | Color* |
| C10 | 0 | 0 | 0 | n.c.**⁾ | 1200 | white |
| C11 | 10 | 5 | 0 | V-0 | 721 | yellow |
| C12 | 0 | 10 | 0 | n.c. | 1100 | yellow |
| C13 | 20 | 0 | 0 | V-0 | 661 | yellow |
| C14 | 0 | 0 | 5% zinc oxide | n.c. | 1189 | white |
| C15 | 0 | 0 | 5% boehmite | n.c. | 1176 | white |

*of test specimen, melt temperature on injection molding: 275° C.

TABLE 4
Inventive examples: flame-retardant molding compositions comprising the
combination of DEPAL with nitrogen-containing synergist and metal oxide
or hydroxide in glass fiber-reinforced PBT

| | DEPAL | MPP | | UL 94 class | | |
|---|---|---|---|---|---|---|
| Example | [%] | [%] | Metal oxide | (0.8 mm) | SV number | Color* |
| E7 | 10 | 5 | 2% zinc oxide | V-0 | 1213 | white |
| E8 | 10 | 5 | 5% magnesium hydroxide | V-0 | 1189 | white |
| E9 | 10 | 5 | 2% magnesium hydroxide | V-0 | 1197 | white |
| E10 | 10 | 5 | 2% boehmite | V-0 | 1168 | white |
| E11 | 10 | 5 | 2% dihydrotalcite | V-0 | 1234 | white |
| E12 | 10 | 5 | 2% manganese oxide | V-0 | 1145 | white |

*of test specimen, melt temperature on injection molding: 275° C.

1. A flame retardant-stabilizer combination for thermoplastic polymers, comprising, as component A, from 25 to 99.9% by weight of a phosphinic acid salt of the formula (I) a diphosphinic acid salt of the formula (II) a polymer of the phosphinic acid salt, a polymer of the diphosphinic acid salt or mixtures thereof 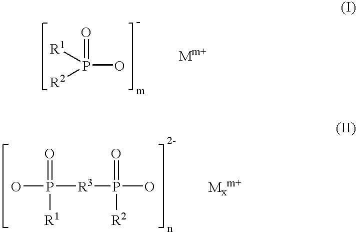
where
R¹, R² are the same or different and are each C₁-C₆-alkyl, linear or branched, or aryl;
R³ is C₁-C₁₀-alkylene, linear or branched, C₆-C₁₀-arylene, -alkylarylene or -arylalkylene;
M is Mg, Ca, Al, Sb, Sn, Ge, Ti, Zn, Fe, Zr, Ce, Bi, Sr, Mn, Li, Na, K or a protonated nitrogen base;
m is from 1 to 4;
n is from 1 to 4;
x is from 1 to 4,
as component B, from 20 to 50% by of melamine polyphosphate and,
as component C, from 0.1 to 50% by weight of basic or amphoteric oxide, hydroxide, carbonate, silicate, borate, stannate, mixed oxide hydroxide, oxide hydroxide carbonate, hydroxide silicate or hydroxide borate or a mixture thereof, the sum of the components being 100% by weight.

2. A flame retardant-stabilizer combination as claimed in claim 1, wherein R¹, R² are the same or different and are C₁-C₆-alkyl, linear or branched, or phenyl.

3. A flame retardant-stabilizer combination as claimed in claim 1, wherein R¹, R² are the same or different and are methyl, ethyl, n-propyl, isopropyl, n-butyl, tert-butyl, n-pentyl or phenyl.

4. A flame retardant-stabilizer combination as claimed in claim 1, wherein R³ is methylene, ethylene, n-propylene, isopropylene, n-butylene, tert-butylene, n-pentylene, n-octylene, n-dodecylene; phenylene, naphthylene; methylphenylene, ethylphenylene, tert-butylphenylene, methylnaphthylene, ethylnaphthylene, tert-butylnaphthylene; phenylmethylene, phenylethylene, phenylpropylene or phenylbutylene.

5. A flame retardant-stabilizer combination as claimed in claim 1, wherein M is a calcium, aluminum or zinc ion.

6. A flame retardant-stabilizer combination as claimed in claim 1, wherein component C is magnesium oxide, calcium oxide, aluminum oxide, zinc oxide, manganese oxide tin oxide or a mixture thereof.

7. A flame retardant-stabilizer combination as claimed in claim 1, wherein component C is aluminum hydroxide, boehmite, dihydrotalcite, hydrocalumite, magnesium hydroxide, calcium hydroxide, zinc hydroxide, tin oxide hydrate, manganese hydroxide, zinc borate, basic zinc silicate or zinc stannate.

8. A flame retardant-stabilizer combination as claimed in claim 1, further comprising from 50 to 80% by weight of component A, from 20 to 50% by weight of component B and from 2 to 20% by weight of component C.

9. A flame-retardant plastic molding composition, comprising a flame retardant-stabilizer combination as claimed in claim 1.

10. A flame-retardant plastic molding composition as claimed in claim 9, wherein the plastic used is a thermoplastic polymer selected from the group consisting of high-impact polystyrene, polyphenylene ether, polyamides, polyesters, polycarbonates and blends or polymer blends of acrylonitrile-butadiene-styrene, polycarbonate/acrylonitrile-butadiene-styrene or polyphenylene ether/high inpact polystyrene.

11. A flame-retardant plastic molding composition as claimed in claim 9 wherein the plastic is selected from the group consisting of polyamides, polyesters and polyphenylene ether/high impact polystyrene blends.

12. A flame-retardant plastic molding composition as claimed in claim 9, comprising from 2 to 50% by weight % of the flame retardant stabilizer combination, based on the plastic molding composition.

13. A flame-retardant plastic molding composition as claimed in claim 9, comprising from 10 to 30% by weight of the flame retardant stabilizer combination, based on the plastic molding composition.

14. A flame-retardant plastic molding composition comprising a flame retardant-stabilizer combination as claimed in claim 8.

15. A polymer article comprising a flame retardant-stabilizer combination as claimed in claim 1.

16. A polymer article as claimed in claim 15, wherein the polymer is selected from the group consisting of high-impact polystyrene, polyphenylene ethers, polyamides, polyesters, polycarbonates and blends or polymer blends of acrylonitrile-butadiene-styrene, polycarbonate/acrylonitrile-butadiene-styrene, polyamide, or polyester, and mixtures thereof.

17. A polymer article as claimed in claim 15 wherein the flame retardant-stabilizer combination is present in an amount of from 2 to 50% by weight, based on the polymer content.

18. A polymer article as claimed in claim 17, wherein the flame retardant-stabilizer combination is present in an amount of from 10 to 30% by weight, based on the polymer content.

19. A polymer article as claimed in claim 15, wherein the polymer article is in the form of a body, film, thread or fiber.
